(19) United States
(12) Patent Application Publication
(10) Pub. No.: US 2005/0104803 A1
(43) Pub. Date: May 19, 2005

(54) High resolution, low segmentation alphanumeric display for electronic devices

(76) Inventor: Christopher Tuason, Houston, TX (US)

Correspondence Address: Christopher Tuason, 1447 Pirates Cove, Houston, TX, 77058, US

(21) Appl. No.: 10/990,043

(22) Filed: Nov. 15, 2004

Related U.S. Application Data
(60) Provisional application No. 60/520,245, filed on Nov. 14, 2003.

(51) Int. Cl. G09G 3/04

(52) U.S. Cl. 345/33

(57) ABSTRACT

A high resolution alphanumeric character display unit is disclosed which has a multi-segmented display screen. The display screen is a mosaic pattern of activatable display segments and dead spaces. The combined dead space accounts for less than 25% of the screen pattern. The activatable display segments have various non-uniform and curvilinear shapes and provide a high resolution alphanumeric character display.

### FIELD OF THE INVENTION

The present invention is in the field of exhibitors. More specifically, the present display relates to exhibitors wherein numbers, letters or symbols are selectively presented by activating one or more of a plurality of elements, such elements being arranged in a matrix which will allow, upon elemental selective activation, the presentation of any of a set characters comprising numbers, letters and/or symbols.

### BACKGROUND OF THE INVENTION

Current alphanumeric character display devices typically comprise a display unit that utilizes a screen defined pattern of display segments that are selectively activated to visually represent a desired character on the screen. The most common display strategy uses a screen pattern having seven display segments with the remainder of the screen pattern being dead space. For example, Smith in U.S. Pat. No. 6,525,700 a character display unit with a display screen having a seven segment configuration. However, even before Smith, it was recognized that there was a need in the field to improve the legibility of the display screen of such devices. Shimakawa in U.S. Pat. No. 3,945,001 discloses a segmented character display unit having nine display segments with curved or rounded features. Additionally, in the Shimakawa display, a plurality of separate display segments are always activated in common by a common lead.

Welch, in U.S. Pat. No. 2,290,261, proposes a display that features curvilinear elements for the purpose of character generation for applications like 3-dimensional electrical neon sign-type vacuum tubes, but lacks the ability to display many characters because of a limited segmentation of elements. The present “HIX8” display invention provides for the necessary segmentation required for a two-dimensional display, typical of LED and LCD technologies.

It would be useful in the field to have an alternative display device for presenting western (i.e., English) alphanumeric characters on a segmented alphanumeric character display unit that has improved legibility and can utilize current display segment activation technologies, such as LED and LCD technologies, and wherein each display segment is individually activatable.

For the given number of display elements, the “HIX8” display of the present invention provides extremely high resolution. Dot matrix displays can be made with a much finer array of dots at the cost of higher processing requirements, but even then they are hampered by the aliasing problem where curved character features can only be produced in a stairstep fashion. This aliasing problem is a major cause of eye fatigue. One strategy used for dot matrix displays to reduce this aliased “block-curve” appearance is to put grey-scale elements at the corners of the steps. Such smoothing schemes come at the expense of clarity. Smoothed dot matrix characters have a fuzzy appearance because the grey-scale solution has a similar effect on the human eye as being out of focus. Whereas the HIX8 display has segments that are curved down to the molecular level so there is no such aliasing problem nor its associated eye strain. 7-segment displays, while costing a minimum of processing, are severely limited in scope and fidelity of character emulation. Prior art 14-segment or 16-segment type of displays are able to produce a greater extent of characters than the 7-segment display, but being composed of rectilinear segments instead of curvilinear segments, they can only display a coarse facsimile of curved character features. So the HIX8 display provides resolution down to the molecular level, much finer than “high-resolution” dot matrix displays, while only incurring a processing cost closer to that of 7-segment displays.

### SUMMARY OF THE INVENTION

The present invention is an alphanumeric display that may use LCD and LED display unit technology to exhibit certain alphanumeric characters and symbols of a character set. The present device provides a high efficiency segmentation geometry in a novel layout. Letters, numbers and certain symbols are formed in high resolution by utilizing a relatively low number of curvilinear and straight display segments to form a mosaic display screen pattern for presenting a desired character. The present invention provides for extremely high resolution character display, achieving better fidelity than dot matrix displays while using the computation power on the order of inexpensive 7-segment or 16-segment displays.

A display unit of the present invention is capable of displaying a single character at a time. A display device of the present invention is one or more display units that may be arranged in a linear array or in a matrix to display multiple characters at a time. A display unit has a display screen is made up of a mosaic of display segments and dead spaces. Display segments and dead spaces are the “tiles” of the mosaic. Each display segment is a single “tile” of the mosaic pattern, and each display segment is separately activatable from every other display segment as actuated by a device such as a decoder chip that converts a binary coded input. Dead spaces are portions of the screen pattern mosaic that are not activatable in the manner of the display segments to produce a character representation on the display screen. A benefit of the present invention is that the proportion of dead space in the display pattern is relatively small, providing more of the pattern's screen area to be utilized to enhance legibility of the displayed character.

The display screen mosaic pattern was accomplished through the distillation the display features of the desired alphanumeric character set into a common set of display segments. More specifically, the characters “H”, “I”, “X” and “8” were used in combination to define the size and shape of the display segments of the mosaic necessary to display all of the typically desired characters—i.e., the numerals 0 to 9, the upper and lower case alphabetical characters, and certain typographical symbols. Overlap of these basic sections delineate the configuration of the display segments that constitute the display and a full set of characters is generated from segments of these four fundamental characters.

For example, in order to generate the character “B”, the left vertical and left crossbeam sections of the character “H” are combined with the curved sections from the right half of the character “8” with the top and bottom of the “B” completed by adding the top left and bottom left crossbeam sections from the character “I”. As another example, the character “G” is generated by combining the upper and lower curve sections from the character “8” with the left central vertical, right lower vertical and right crossbeam sections from the character “H”. The present high resolution display unit has the advantage over other displays that have a substantially lower number of display segments (such as seven segment displays) in that characters can still be determined unambiguously when certain display segments are obscured or broken. An advantage of the present display unit over dot matrix displays is that curvilinear display segments provide characters having an outline or perimeter that is smooth and not aliased. Since the linear and curved sections are represented in high resolution, the resulting characters built from these sections are high resolution as well.

Several characters have multiple representations using this segmentation layout. This feature enables different font types to be portrayed when applying distinguishing traits throughout an entire character set. The decoder chip to translate character code (such as ASCII) into individual segment activation may be tailored to specific font types. For implementations of the present display that use non-uniform illumination methods, such as LEDs (as opposed to a uniformly backlit LCD) the output intensity for each display segment is set so that the composite characters appear uniformly lighted.

The present segmented display unit can be modified by reducing the total number of display segments comprising the unit. This can be accomplished through the unification of tiny segments into predominantly larger segments, as well as through the elimination of delineations between display segments that aren't required for any characters throughout a full character set or simply by not activating unnecessary segments. The reduction of the total number of display segments can serve to reduce complexity and cost for associated electronics while having an acceptable impact on display readability.

### BRIEF DESCRIPTION OF THE DRAWINGS

FIG. 1A is a schematic representation of five display units, each with a mosaic of display segments for a 100 segment display unit of the present invention.

FIG. 1B is a comparison of prior art 7-segment, 14-segment and dot matrix display examples with the present invention.

FIG. 2 is an illustration of a number of display units of the present invention, each unit displaying a different alphanumeric character or symbol.

FIG. 3 shows a schematic representation of an alternative display unit configuration enabling an alternative character font.

FIG. 4 shows examples of display units of the present invention depicting an alternative screen mosaic configuration of display segments for presenting the characters “A”, “B”, “C” and “3” in an alternative font along with a representation of the “OE” and “AE” diphthong ligatures. The depicted mosaic for the character “B” can alternatively be used as a German sharp-s (also known as “scharfes s” or “eszett”).

FIG. 5A is a schematic representation of an alternative display unit configuration,having a reduced number of display segments relative to that of FIG. 1A.

FIG. 5B is a schematic representation of a further alternative display unit configuration having a reduced number of display segments relative to that of FIGS. 1A and 5A.

FIG. 5C is a schematic representation of an alternative display segment mosaic for a 45 segment display unit that can produce all digits 0-9 among other characters.

FIG. 5D is a partly perspective exploded view of a three-layer LCD-type alternative method for a display unit configuration having a reduced number of display segments relative to that of FIG. 1A.

FIG. 6 is a schematic representation of an alternative display segment mosaic for presenting a character set that includes accent segments and segments that extend below the baseline (“descender” segments).

FIG. 7 is an illustration of a number of display units of the present invention to demonstrate that letters in the “HIX8” mosaic pattern are not limited to the Roman alphabet. Cyrillic and Greek letters are shown as an example.

### DETAILED DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix.

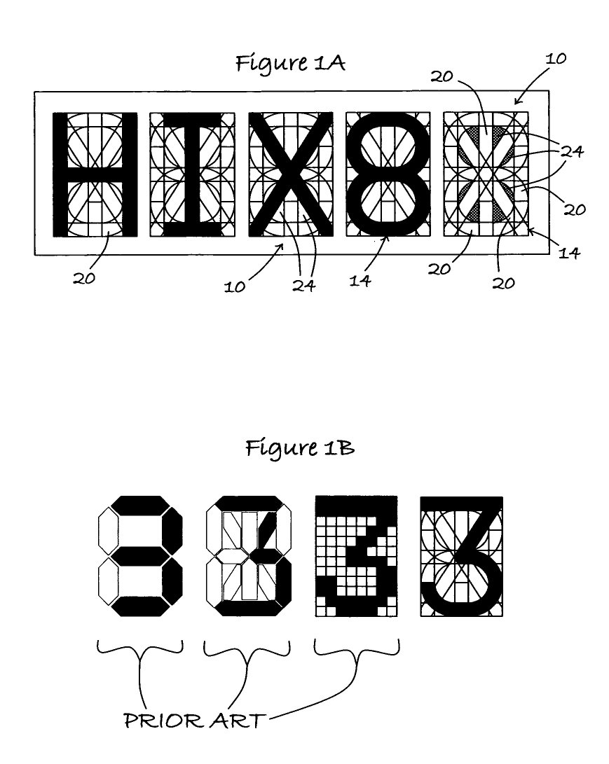

The present invention is a high resolution alphanumeric character display device that is suitable for use with display character display technologies utilizing a segmented screen geometry to display alphanumeric and typographical symbol characters. Examples of such display technologies include LED and LCD displays. The present device is high resolution in that it constructs the alphanumeric characters with a combination of curved and straight component segments in a segmentation geometry that provides high resolution. The gaps between segments can be made vanishingly small down to the manufacturing limit of the display technology to yield characters that appear whole, not fragmented, as with current segmented displays. The present display device is made up of one or more alphanumeric character display units 10 illustrated in FIG. 1A. In the preferred embodiment illustrated, the display unit 10 is designed to display high resolution representations of the alphanumeric characters: “H,” “I,” “X” and “8.” Consequently, the resultant segmented display unit 10 has the capability to display all of the other Western alphanumeric characters.

A display unit 10 has a segmented display screen 14 comprising a mosaic of a plurality of display segments 20 and dead spaces 24. The individual display segments 20 of the screen mosaic 14 are each separately selectable for activation, and are variously configured in non-uniform and curvilinear shapes. The display segments 20 are non-uniform in that they do not all have substantially the same shape when activated on the display screen 14, and in fact comprise a number of different shapes, although there is symmetry between some of the shapes. The display segments 20 are curvilinear in that the various shapes have curved and/or straight features and are not all substantially straight.

The display segments 20 and dead spaces 24 are disposed in a mosaic pattern to form the display screen 14. The individual display segments 20 and dead spaces 24 are adjacently arranged to form the display screen mosaic 14. The display screen mosaic 14 is substantially filled by the display segments 20, with relatively little of the screen 14 consisting of dead spaces 24. In a preferred embodiment, the dead spaces 24 account for less than about 15% of the display surface of the display screen 14, to facilitate the high resolution feature of the display unit.

If desired, the number and/or configuration of the display segments 20 and the dead spaces 24 can be changed as selectable by the ordinary skilled artisan to accomplish an alternative desired benefit, e.g., to simplify the associated circuitry. Preferably, the number of selectable display segments 20 comprising the display screen 14 ranges from about 45 to about 110 display segments 20.

FIG. 1B shows a side-by-side comparison of prior art 7-segment, 14-segment and dot matrix display examples along with the present invention, each displaying the character “3”. The dot matrix display example shown in FIG. 1B has 96 elements, roughly comparing to the number of elements in the HIX8 display.

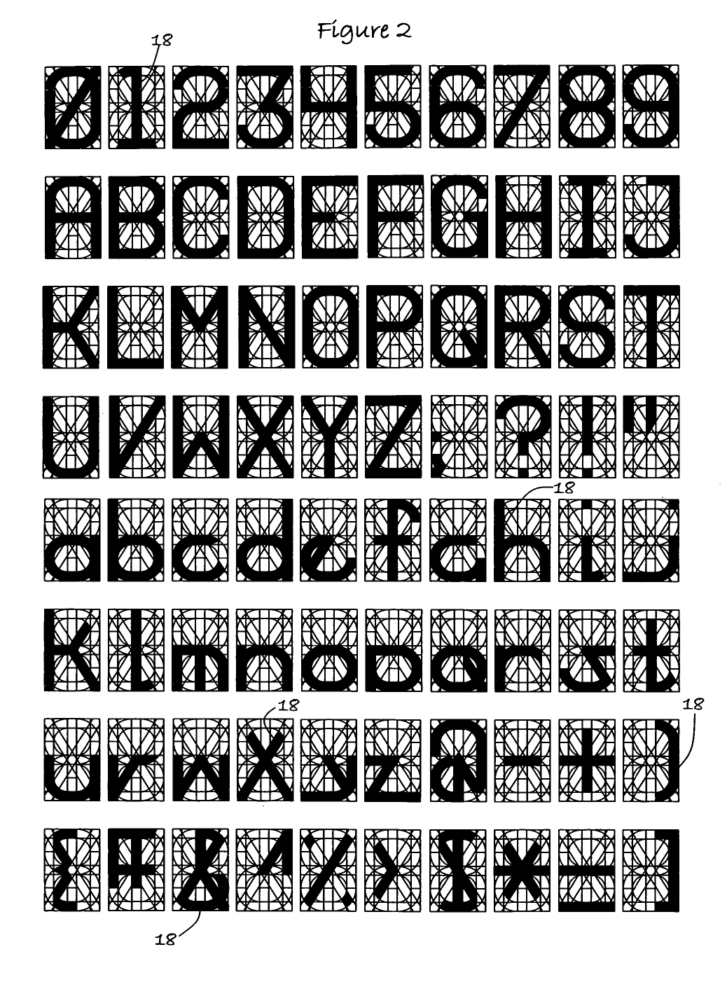

As illustrated in FIG. 2, a character set of letters, numbers and certain typographical symbols are formed in high resolution on the display screen 14 of a display unit 10. Each character is formed of a specific character pattern 18 using a number of display segments 20 as illustrated by the exemplary character set of FIG. 2. Since the linear and curved configurations of the display segments 20 are represented in high resolution, the resulting character mosaics 18 comprised of these display segments 20 will be high resolution as well.

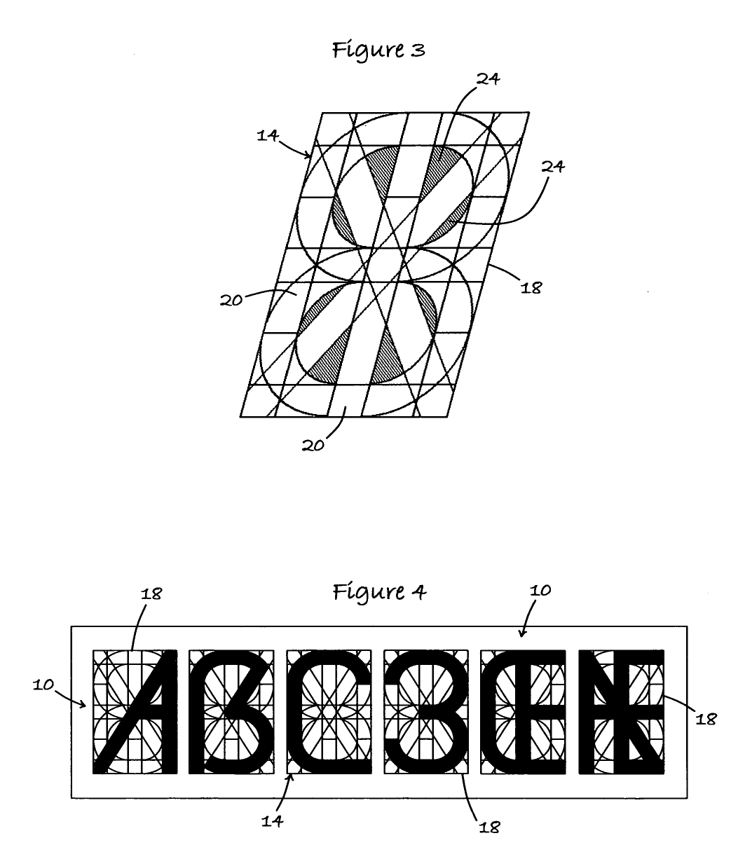

FIG. 3 illustrates the present display unit 10 having a display screen mosaic 14d configured to provide a character set having an alternative font (i.e., italicized) relative to that illustrated in FIG. 2 as an example of one of the various linear or non-linear transformations to the display screen mosaic 14. With or without altering the display screen mosaic 14, several characters of the preferred character set (see FIG. 2) have alternate representations that can be displayed on the display screen 14. For example, FIG. 4 illustrates alternative character mosaics 18 for presenting the characters “A”, “B”, “C” and “3” utilizing the same character set and display screen 14 of FIG. 2. The depicted mosaic for the character “B” can alternatively be used as a German sharp-s (also known as “scharfes s” or “eszett”). FIG. 4 also shows example character mosaics for the diphthong ligatures “OE” and “AE”.

In the preferred embodiment illustrated in FIG. 2, the display segments 20 and dead spaces 24 of the display screen 14 are disposed in a mosaic pattern to form individual character from the character set consisting of the numerals 0 to 9, upper and lower case alphabetical characters, and certain typographical symbols. Of course, other character set having additional characters and alternative character fonts, as well as alternative configurations of the display unit 10 are selectable by one of ordinary skill in the art for practice in the present invention in view of the teachings and figures herein.

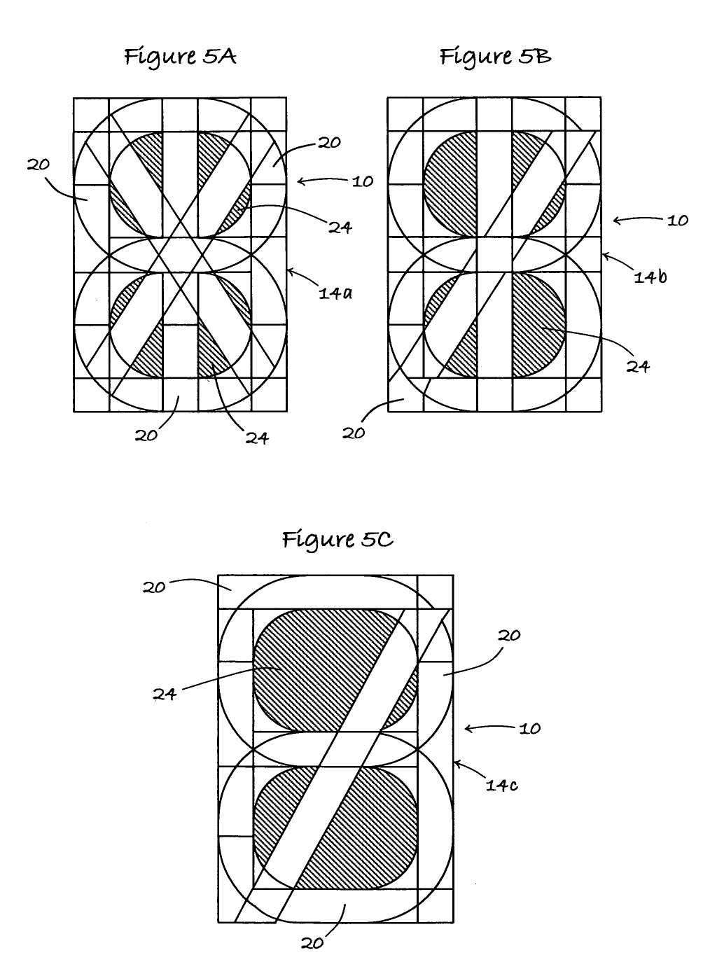

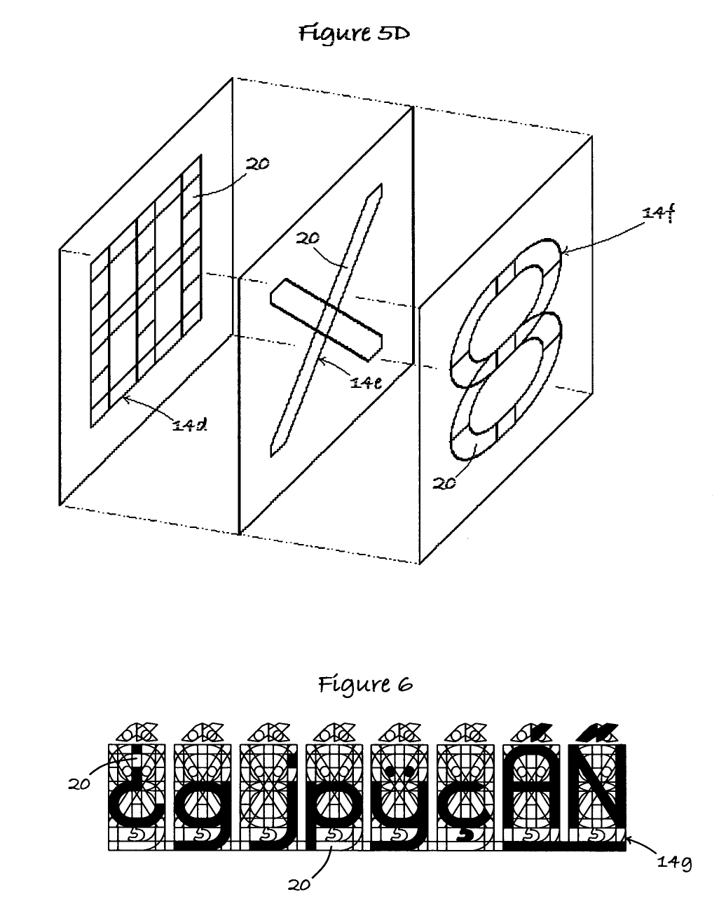

The preferred display unit 10 of the present invention illustrated in FIG. 1 having about one hundred segment display screen mosaic 18 can be adapted to have a reduced number of display segments 20 by incorporating the relatively tiny segments into the shape configuration of one or more adjacent larger display segments 20. For example, FIG. 5A illustrates an embodiment of a seventy-nine segment display screen 14a. FIG. 5B illustrates an exemplary embodiment of a 66 segment display screen 14b. FIG. 5C illustrates an example of a 45 segment display screen 14c that is designed primarily to display the numerals 0 to 9. FIG. 5D is a partly perspective exploded view of a three-layer LCD-type alternative method for a display unit configuration having a reduced number of display segments relative to that of FIG. 1A. Each of the three layers is transparent so that the activated segments form a summation to display whole characters. Other embodiments of the present display unit 10 having various display screen mosaics are selectable by the ordinary skilled artisan for practice in the present invention in view of the teachings and figures contained herein.

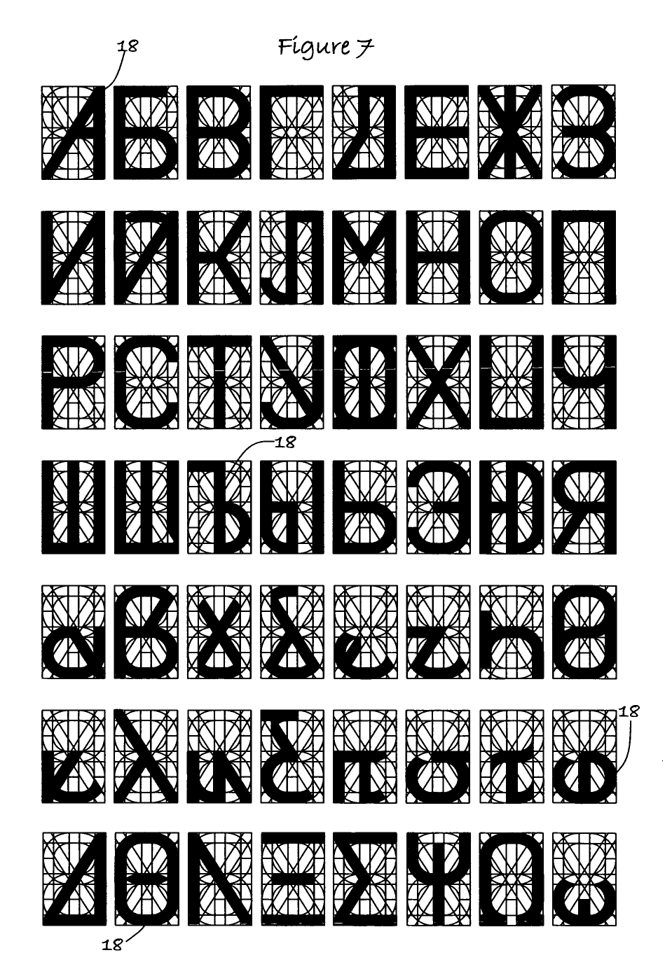

FIG. 6 is a schematic representation of an alternative display segment mosaic for presenting a character set that includes accent segments and segments that extend below the baseline (“descender” segments). In tailoring the present invention to a font for a particular language, part or all of such additional segments beyond the basic HIX8 pattern can be used. For example, an English-specific embodiment can add only the descender segments for the lower case characters “g”, “j”, “p”, “q” and “y” along with the additional underline segments. Other modifications to the basic HIX8 pattern are possible to enable the display of characters from different languages or special symbol characters.

FIG. 7 is an illustration of a number of display units of the present invention to demonstrate that letters from the “HIX8” mosaic pattern are not limited to the Roman alphabet. Cyrillic and Greek letters are shown as an example. Design of a Unicode Standard decoder interface is obvious to a person of ordinary skill in the art. The mosaics shown for the lower case Greek letters alpha, beta, delta, epsilon, zeta, kappa, mu, sigma and tau can also be used as an alternate font for the Roman letters “a”, “B”, “d”, “e”, “z”, “k”, “m”, “s” and “t”, respectively. The mosaics shown for Cyrillic capital letters have alternative fonts for the Roman letters “A”, “Y”, “W” and “b”.

The present high resolution alphanumeric character display device 10 has a segmented display screen 14, the display screen being a mosaic pattern 16 of a plurality of display segments 20 and dead spaces 24. The display segments 20 are selectably activatable and have various non-uniform and curvilinear shapes. The combined dead spaces 24 of the display screen 14 is less than 25% of the screen mosaic pattern 16, and preferable less than about 15%.

An alternative embodiment of the present invention has no “dead space”, wherein all segments are activatable. Such a display can be useful in applications like electronic book displays where small characters with high resolution are desireable. By enabling the activation of would-be dead spaces, a rectangular array of many such small character can be used to display large letters in a dot matrix format.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

1. A high resolution alphanumeric character and symbol display device comprising:
a segmented display screen;
a plurality of selectable display segments, the display segments being variously non-uniform and curvilinear; and
the display segments being disposed adjacently in a substantially full segment pattern to provide the high resolution display device.

2. The display device of claim 1, wherein the plurality of selectable display segments consists of at least about 45 to 110 display segments per segmented display pattern.

3. The display device of claim 1, wherein the display segments disposed in the pattern are selectable to form an individual character selected from the group of character consisting of: the numerals 0 to 9, upper and lower case alphabetical characters, and typographical symbols.

4. The display device of claim 1, wherein the substantial full display pattern of display segments has a dead space of less than 15 percent of the full display pattern.

5. A high resolution alphanumeric character display device comprising:
at least one display unit having a segmented display screen; the display screen having a screen pattern of display segments and dead spaces, with a combined dead space of less than 25% of the screen pattern;
a plurality of selectably activatable display segments, the display segments each having a shape, the shapes being variously non-uniform and curvilinear; and
the display segments and dead spaces being adjacently disposed in the screen pattern to provide the display unit of the high resolution alphanumeric character display device.

6. The high resolution alphanumeric character display device of claim 5, wherein the combined dead space is less than 15% of the screen pattern.
